(19) United States
(12) Patent Application Publication
(10) Pub. No.: US 2020/0315114 A1
(43) Pub. Date: Oct. 8, 2020

(54) PREVENTING TREATING AND ELIMINATING INFECTION AND INFESTATION OF PLANTAE IN SENSU LATO BY PATHOGENS AND PESTS

(71) Applicant: Charles E. Ankner, West Palm Beach, FL (US)

(72) Inventor: Charles E. Ankner, West Palm Beach, FL (US)

(21) Appl. No.: 16/907,286

(22) Filed: Jun. 21, 2020

Related U.S. Application Data
(63) Continuation-in-part of application No. 15/628,689, filed on Jun. 21, 2017.
Application No. 15/628,689 is a continuation-in-part of application No. 15/455,805, filed on Mar. 10, 2017, now Pat. No. 10,631,479.
Application No. 15/455,805 is a division of application No. 14/046,050, filed on Oct. 4, 2013, now Pat. No. 9,622,426.

(51) Int. Cl. A01G 31/02; A01G 22/00

(52) U.S. Cl. CPC A01G 31/02; Y02P 60/216; A01G 22/00

(57) ABSTRACT

A method and system relating to utilizing plant shoot to root temperature differentials and gas mixture humidity to prevent, treat, control, or eradicate infection by plant pathogens and/or infestation by plant pests. The timing, sequence, and range of shoot-to-root temperature differentials selected during plant development may be utilized to prevent, treat, control, and/or eradicate plant pathogens and/or plant pests; and, thereby improve plant growth for industrial, scientific, and medical purposes and uses.

### CROSS REFERENCE TO RELATED APPLICATIONS

The instant application is a continuation-in-part of U.S. patent application Ser. No. 15/628,689, filed Jun. 21, 2017, entitled Method of Improving the Growth and Production Output of Plants of the Family Solanaceae, published as U.S. Patent Application Publication No. 2017/0280643, which is a continuation-in-part of U.S. patent application Ser. No. 15/455,805, filed Mar. 10, 2017, entitled Method of Improving the Growth and Production Output of Plants of the Family Cannabaceae sensu stricto, published as U.S. Patent Application Publication No. 2017/0181392, and now U.S. Pat. No. 10,631,479, which is a division of U.S. patent application Ser. No. 14/046,050, filed Oct. 4, 2013, entitled Method of Improving the Growth and Production Output of Plants of the Family Cannabaceae sensu stricto, published as U.S. Patent Application Publication No. 2015/0096230 A1, and now U.S. Pat. No. 9,622,426. The contents of the above referenced applications are herein incorporated in their entirety by reference.

### FIELD OF THE INVENTION

The instant inventive method and system relates to plant husbandry. More specifically, the instant invention relates to a system and method of and for utilizing shoot-to-root temperature differentials and/or utilizing changes in psychrometric parameters with and on a plantae in sensu lato organism (hereinafter, a “plant”) to prevent, control, treat, or eradicate infection by a plant pathogen and/or infestation by a plant pest.

### BACKGROUND OF THE INVENTION

In the beginning God made heaven and earth . . . . Then God said, ‘Behold, I have given you every seed-bearing herb that sows seed on the face of all the earth, and every tree whose fruit yields seed; to you it shall be for food. I also give every green plant as food for all the wild animals of the earth, for all the birds of heaven, and for everything that creeps on the earth in which is the breath of life.’ It was so. Then God saw everything He had made, and indeed, it was very good. So evening and morning were the sixth day. Book of Genesis, Chap 1:1, 29-31, commonly attributed to the Yahwist, circa 5th Century B.C.E, as translated and interpreted in The Orthodox Study Bible: Ancient Christianity Speaks to Today's World, Thomas Nelson Publishing, 2008, USA.

. . . the greatest service which can be rendered to any country is to add a useful plant to its culture; especially a bread grain, next in value to bread, is oil., Thomas Jefferson, 3rd President of the United States of America, Memorandum of Services to My Country, 1800, Charlottesville, Va., USA.

You don't need another hobby . . . , Teresa A. (Ettles) Ankner, late wife of instant inventor, throughout their twenty-three-year marriage, USA.

In known plant husbandry methods and systems, the temperature of a plant growing medium, such as soil, soil replacements, liquids, reservoirs, aquaponic misting, and the like; maintain plant root system temperature within a few degrees of that of the air/gas mixture about the plant shoot. In other words, in known plant husbandry methods and systems, “the plant roots are maintained as hot or as cold as the plant shoot”.

Lowering plant growing medium and/or nutrient solution temperature, dissolved oxygen saturation levels of the nutrient solution within the growth medium may be increased which in turn increases oxygen and nutrient uptake by the plant. In basic terms; the lower the growth medium temperature and nutrient solution, the more oxygen may be dissolved within the solution; which increases dissolved oxygen and increases permeability of plant roots to water and minerals, which increases plant water and nutrient uptake; thus, increasing the overall growth rate and health of the plant.

As may be deduced, there is interplay between plant solution oxygen solubility and plant nutrient uptake. As oxygen solubility increases, so does nutrient uptake. Ordinarily, this increase would be viewed as advantageous; however, in many or most hydroponic or aquaponic growing methods and systems, as well as in irrigated outdoor farming, nutrient solutions and/or fertilizers have preferred and specific nitrogen-phosphorous-potassium (hereinafter “N—P—K”) concentrations tailored to specific varieties of plants, and further tailored to the growth phases of those plant varieties and varietal strains being grown. Many of these N—P—K formulations are high in concentration and intended to maximize crop yield; and yet be at levels just below a point which begins to damage or “chemically burn” or “overdose” the plant. As selected plant nutrient solution temperatures are lowered, the increased nutrient uptake of the plant requires differing solution N—P—K concentration levels and ratios to improve overall plant development without damaging or chemically burning the plant.

As is also well known in plant husbandry, in many plant varieties, higher growth medium and nutrient solution temperatures can cause root system oxygen starvation. As temperature increases, nutrient solution oxygen solubility dramatically decreases, and the plant essentially suffocates. Plant injury from hypoxia (low, or no oxygen) at the roots may take several forms, each differing in severity and depending upon the plant family and variety.

Typically, the first sign of root suffocation is wilting of the plant shoot during the warmest part of the day when temperatures and light levels are highest; or the overall wilting of plants grown with artificial illumination in controlled conditions. Insufficient oxygen reduces the permeability of roots to water and results in the accumulation of toxins, thus both water and minerals cannot be absorbed in quantities sufficient to support plant growth, particularly under plant stress conditions.

This wilting is accompanied by lower rates of photosynthesis and carbohydrate transfer; and over time, plant growth is reduced and crop yields negatively affected. If oxygen starvation continues, mineral deficiencies set-in, causing absorbent root villus and mircovillus loss leading to root die back; thus, starving and stunting the plant. Under these continuing anaerobic conditions, plants produce stress hormones which accumulate in the roots and cause collapse of root cells. Once root injury and deterioration caused by anaerobic conditions has begun, common opportunist pathogens such as pythium, fusarium, verticillium, rhizoctonia, and the like, can and do easily infect and rapidly destroy the plant. To compound this root vulnerability, higher growth medium, water, and/or nutrient solution temperatures provide a fertile habitat for many plant pathogens and pests.

In such tragic cases, even highly trained and experienced agriculturalists and horticulturalists mistakenly treat this “root rot” by attempting to prevent or destroy pathogens by using various techniques and/or chemicals. Known and yet undesirable methods attempting to prevent and/or treat “root rot” include: filtering the nutrient solution by reverse-osmosis; “sterilizing” the nutrient solution with hydrogen-peroxide, ozone, or other chemical; irradiating the nutrient solution with high intensity ultraviolet light; and also by “inoculation” by introducing a so called “beneficial pathogen or pest” to prevent or destroy an “unwanted pathogen or pest”.

A known public domain aspect of plant cultivation is gas mixture carbon-dioxide augmentation. Introducing supplemental carbon-dioxide into ambient air about a plant shoot is known to increase crop yield up to approximately 30%. This increase is caused by improved plant transpiration and thus improved photosynthesis and carbohydrate transfer. A further aspect of this known method is that due to improved plant transpiration, the plant can withstand higher shoot temperatures, and correspondingly higher levels of luminance intensity. Higher levels of luminance intensity results in improved photosynthesis, and typically an additional 20-30% improvement in crop yield.

Above the root crown (i.e. the plant shoot), opportunistic plant pathogens and pests can and do quickly infect, infest, and destroy plants. Such known pathogens and pests include but is/are not limited to; invertebrates, protozoans, nematodes, fungi, molds, mildews, bacterium, viruses, insects, arachnids, small vertebrates, cold-blooded reptiles, and the like, and combinations thereof.

A known public domain aspect of plant cultivation is the water vapor content of an air/gas mixture about a plant shoot at a given temperature; that is, relative humidity. Typically, in plant husbandry, growing methods and systems provide a preferred 90-100% relative humidity for seedlings and cuttings, a 40-80% relative humidity for most vegetative plants and some flowering plants, and a 20-35% for flowering or some fruiting plants.

In all known growing methods and systems, a preferred relative humidity is almost exclusively provided to facilitate a robust environment to benefit plant growth; but, not provided to prevent, control, treat, and/or eradicate a plant pathogen or pest.

Known and yet undesirable methods attempting to prevent and/or treat pathogens and pests at and/or above the plant shoot typically include organic and/or chemical pesticides, herbicides, repellants, and the like; most being expensive, very labor intensive to apply, and very environmentally toxic once applied.

Corresponding to direct damage caused by plant-eating (i.e. phytophagous) insects, many insects, especially those with piercing mouthparts (e.g. aphids and leafhoppers), may easily transfer viruses from plant to plant as they extract plant juices, thus spreading at times fatal phyto-disease.

Consequences of unseasonal changes in temperature (i.e. late frosts, early summers, and the like) and their effects on host plants and pests are well known. While unseasonably high temperatures may lead to greater plant productivity, they also afford many insects an opportunity to complete additional generations during a growing season, leading to increased population.

Conversely, colder episodes, especially out of season, may regulate pest populations by killing either insects which have emerged from winter hibernation, or spring hatching. Many insect species have threshold temperatures below which they will not be active and/or will perish; which varies from insect family to family.

Fungal diseases of plants are caused by fungal spores landing on and infecting the leaves and stems of plants. Common examples include mildew, wilt, and rust diseases of leaves. Both air and water movement play a significant role in controlling the spread and development of fungal diseases in plants. Except for short periods after rain, suspended microorganisms are rarely absent from the air.

For insect movement, daily and seasonal patterns of airborne spores and pollen are well known. However, while insects generally have a degree of control over their movements in the air, airborne pathogens and pests do not; and their airborne spread and subsequent impact occurs largely at the whim of the elements. While plant pollen is not normally considered a pest, many fungal spores on plant pollen cause a wide range of diseases in fruit, vegetables, ornamental plants, and trees. Fungal spores may enter an area by being blown on the wind or via the air intakes of environmentally controlled systems; but more commonly in the case of short-distance dispersal, fungal spores disperse locally from plant to plant through transport in water splash or water runoff (rain or dew) from leaves. Fungal spores may also be carried by insects through the transfer of infected plant material.

Generally, many fungi thrive in warm and humid conditions and comprise an important component of the ecological cycle in composting; however, many fungal species also require changes in humidity to trigger their release through either specific wetting or drying actions. Consequently, in nature, dawn (the time of dew evaporation) is a favored time for release of pollen in many common fungal species. The continued presence of water surrounding vegetation at that time of day may also encourage their subsequent infestation of neighboring plants.

While not intended to be exhaustive, and being provided by way of example only and not by way of limitation; pests and pathogens which are harmful and possibly deadly to a plant may include but are not limited to: aphids, barnacle/scale insects, broad mites, spider mites, flower rot or mold, caterpillars, inchworms, crickets, fungus gnats, fungi, grasshoppers, leafhoppers, leaf miners, mealybugs, root rot, slugs/snails, thrips, tobacco mosaic virus (TMV), whiteflies, white powdery mold, armyworm, cabbage looper, cabbageworm, codling moth, corn earworm, pickleworm, tomato hornworm, fruit fly, leafhopper, pea weevil, pepper maggot, asian lady beetle, asparagus beetle, bean leaf beetle, blister beetle, colorado potato beetle, corn rootworm, cucumber beetle, curculio, flea beetle, japanese beetle, lily leaf beetle, mexican bean beetle, sweet potato weevil, european corn borer, peach tree borer, squash vine borer, carrot rust fly, celery leaftier, cutworm, earwig, fire ant, nematodes, root maggot, root weevil, wire worm, four-lined plant bug, harlequin bug, tarnished plant bug, squash bug, stink bug, angular leaf spot, bacterial blight, bacterial spot, bacterial wilt, corn leaf blights, downy mildew, early blight, late blight, powdery mildew, septoria leaf spot, white mold, clubroot, blossom-end rot, catfacing, corn smut, phytophthora fruit rot, potato scab, anthracnose, black rot, and the like.

Vertebrate pests may include animals and birds which nibble and peck (e.g. rabbits, mice, squirrels, and birds), dig (e.g. moles and gophers), or generally scavenge in nature. As in the case of insects and micro-organisms, plants offer vertebrate pests a highly specialized and modified habitat with an abundant, although often limited, seasonal food supply. Although most animal and bird pests can do significantly more damage than insects or fungi, the range of vertebrate pests found in typical gardening and agriculture environments is normally less than the range of insect pests and micro-organisms. A few rabbits can clear a lettuce patch much more efficiently than many caterpillars in the same amount of time.

Generally, wind as a vehicle of dispersal is less important to animals and birds than it is to insects and micro-organisms; although obviously some birds will not fly if it is too windy. Instead, the single most important environmental and/or weather condition affecting the behavior of animals and birds in gardens is most probably temperature; although excessive rainfall leading to local flooding may also be important for relatively short periods.

Drought is usually less of a problem to vertebrate pests, especially if there are ponds, gutters, or water-barrels to drink from; including fluids available in garden and agricultural waste. Because most vertebrates, especially mammals, control their own body temperature, they are capable of surviving at a much wider range of ambient temperatures than other pests.

Known plant growing methods and systems include:

U.S. Pat. Appln. No. 2012/0210640 by Ivanovic discloses a hydroponic growth system wherein nutrient solution temperature is an environmental parameter monitored and controlled by automatic means.

U.S. Pat. Appln. No. 2009/0223128 by Kuschak discloses a hydroponic growth system wherein nutrient solution temperature is an environmental parameter monitored and controlled by automatic and remote means.

U.S. Pat. No. 8,443,546 to Darin discloses a hydroponic growth system wherein a small self-contained water chiller is optionally provided for reducing high nutrient solution reservoir temperatures caused by close proximity to high heat illumination sources.

U.S. Pat. No. 6,216,390 to Peregrin Gonzalez discloses a hydroponic system wherein the nutrient solution temperature is utilized to maintain the air temperature about the plants being grown.

U.S. Pat. No. 5,813,168 to Clendening discloses a greenhouse hydroponic system wherein the nutrient solution temperature is held at approximately 55° F. and utilized to maintain the air temperature about the plants being grown.

U.S. Pat. No. 5,771,634 to Fudger discloses a small home-style computer controlled hydroponic system which automatically maintains various growing parameters such as air temperature, air humidity, illumination cycles, and nutrient solution recirculation.

U.S. Pat. No. 5,501,037 to Aldokimov, et al. discloses an industrial hydroponic system wherein the frequency and duration of nutrient solution release is modified and controlled in accordance with the ambient air temperature.

U.S. Pat. No. 4,669,217 to Fraze is directed to and discloses among other things a modularized, computer controlled, twin (upper and lower) compressed gas activated nutrient solution reservoir plant propagation system, for integration installation and use in greenhouses. Stated relevant objects of Fraze include: “ . . . to provide a plant propagation system and apparatus that is computer controlled to achieve optimum or maximum plant growth potential.” (Col. 2 Ln 61-64), “ . . . to provide a plant propagation system and apparatus in which the parameters of plant growth rate and maturity, nutrient temperature, plant exposure to nutrient time, air temperature, air humidity and nutrient quality are controlled by a computer to achieve optimum or maximum plant growth potential.” (Col. 2 Ln. 65-68-Col. 3 Ln 3); and “ . . . to provide a plant propagation system and apparatus utilizing a two-reservoir nutrient system in which nutrient is periodically transported from a first reservoir to a second reservoir containing the roots of the plant being propagated and back to the first reservoir whereby the plant roots are cyclically exposed to the nutrient solution . . . ” (Col. 3 Ln 9-14).

Taiwan Pat. Appln. No. TW 20080106998 by Chen discloses a hydroponic method which holds plant nutrient solution temperature at 64° F. during winter and 72° F. during summer so plants survive ambient air temperature extremes and reduce the cost of maintaining the ambient air temperature about plant shoots to between 41° F. and 95° F., while preventing plant damage at ambient air temperatures above and below that range.

Chinese Pat. No. CN1253715A to Zhaozhang discloses a method of planting young fruit trees out of season by providing heating pipes about the tree root system, trunk, and branches.

Chinese Pat. Appl. No. CN101653089A by Wu discloses a method of protecting crops from low ambient air temperatures by providing irrigation pipes about the plant root system and supplying warm irrigation solution to keep both the root system and by evaporation the plant shoot system warm.

No known method or system discloses or teaches providing a temperature differential between the shoot and root systems of a plant for any reason or for any purpose; nor do they state, suggest, imply, nor infer any motivation for one of ordinary skill in the art to do so.

Moreover, all known methods and systems teach away from providing a plant shoot to root temperature differential; indicative of the still common and yet entirely errant notion that plant shoot temperature and plant root temperature should be approximately the same throughout all growth phases of plant development.

No known method or system discloses or teaches utilizing changes in psychrometric parameters to prevent, control, treat, and/or eradicate a plant pathogen or pest; nor do they state, suggest, imply, nor infer any motivation for one of ordinary skill in the art to do so.

In Growth Responses of Hemp to Differential Soil and Air Temperatures, by Clarence H. Nelson, Plant Physiol. 1944 April; 19(2): 294-309, (hereinafter “Nelson”, and hereby incorporated by reference in its entirety) explains that specific development changes occur in C. sativa L. plants (i.e. hemp sativa) grown in such temperature differential environments.

Nelson experimenters placed C. sativa L. into four unchanged temperature conditions (series), remaining unchanged throughout the vegetative growth of the plants. The four temperature conditions Nelson used where:

Shoot at 86° F., and roots at 86° F., (hereinafter “H/H”).

Shoot at 86° F., and roots at 60° F., (hereinafter “H/L”).

Shoot at 60° F., and roots at 86° F., (hereinafter “L/H”).

Shoot at 60° F., and roots at 60° F., (hereinafter “L/L”).

Nelson observed and concluded: All four temperature series plants developed uniformly for the first four weeks of growth, with significant developmental changes being observed after seven weeks of growth.

The H/H plants: Vegetative growth was the most robust, with the smallest internodal length and stem diameter until maturity, and with the greatest root development. Specifically, H/H series plants exhibited the maximum stem elongation; greatest number of nodes produced; earliest blossom and seed formation; least aggregate leaf area; greatest number of leaf abscissions; and the highest absolute water consumption during growth.

The H/L plants: Both the aggregate number of leaves produced and the total leaf area per plant where smaller than in any other series. The leaves themselves were relatively thin and more finely veined. This series showed the least anabolic efficiency as noted by their low fresh and dry weight per plant. There was a possibility of impaired translocation of reserves into the region below the ground line due to low root temperatures.

The L/H plants: Had the maximum stem diameter and greatest internodal length. Leaves were very coarse in texture, large in size, and extremely thick. Leaf abscission was lowest of the four series, and leaf and stem production was favored. Plants of this series had the largest stem diameter, largest individual leaves, and highest aggregate dry weight.

The L/L plants: The leaves on these plants were relatively large, attaining the maximum area per leaf of the four series. Though the stems attained a height only slightly greater than in the L/H plants, the stem diameter was relatively large. The vegetative habit was essentially similar to L/H plants except as to stem length.

However, Nelson is completely and utterly silent related to plant pests or pathogens. Nelson did not have as an objective, nor did Nelson experimentation utilize, plant shoot-to-root temperature differentials for the prevention, control, and/or eradication of plant pathogens and/or pests.

Dutch Pat. Appln. No. NL1020694 to/by Korsten (hereinafter “Korsten”) discloses making use of the principle of an inverted or reverse temperature gradient for saving energy heating a greenhouse environment. By placing the plants as close together as possible, combined with the use of insulating materials placed around the plant containers, a 20-30% energy saving is purported by creating a “micro-climate” about each plant (disclosed as a 1-meter space or sphere about the plant).

Korsten also discloses a 7° C. temperature gradient between the greenhouse environment and the growing medium about the plant roots. However, Korsten fails to disclose a distance from the plants from which this gradient extends. Therefore, the 7° C. temperature gradient value disclosed is meaningless. However, if the distance from the plant is presumed to be the disclosed “micro-climate” of 1 meter, then it can be inferred that Korsten discloses a temperature gradient of no greater than 7° C. for every 1-meter distance from the plant root system.

A stated objective of Korsten is to save energy in heating a greenhouse by grouping plants together, providing heat to the growing medium about the roots, and creating a “micro-climate” about the plants, and that this “micro-climate” will aid a grower in providing more controllable cultivation during plant flowering or fruiting morphology.

However, Korsten fails to disclose or teach a method of providing a temperature differential between the shoot and root systems of the plant for the purpose of preventing or treating plant pathogens and/or pests; nor does Korsten state, suggest, imply or infer any motivation to do so. Korsten is also completely silent related to plant pests and/or pathogens.

It is known that when water in plants freezes, damaging consequence depends greatly on whether freezing occurs within plant cells (intra-cellular) or within spaces outside plant cells (inter-cellular). Plant intra-cellular freezing, which usually kills the cell regardless of the hardiness of the plant and its tissues, seldom occurs in nature because rates of cooling are commonly not high enough to support it. Rates of cooling of several degrees Celsius per minute is typically needed to cause intra-cellular ice formation in plants. At rates of cooling of a few degrees Celsius per hour, segregation of ice occurs in inter-cellular spaces; which may or may not be lethal depending on the hardiness of the plant tissue. At freezing temperatures, water in the inter-cellular spaces of plant tissue freezes first, though water may remain unfrozen until temperatures drop below 19° F. (−7° C.). After initial formation of inter-cellular ice, plant cells shrink as water is lost to segregated ice, and the cells undergo “freeze-drying”. This inter-cellular freeze-drying (i.e. dehydration) is strongly evidenced as the fundamental cause of plant freeze injury and subsequent plant death.

Plants protect themselves from cold stress with sugars, antifreeze proteins, and heat-shock proteins. Abundant late embryogenesis protein expression is induced by stresses and protects other proteins from aggregation due to cell freezing and desiccation. Plant antifreeze proteins differ from other antifreeze proteins in having much weaker thermal hysteresis activity, their physiological function likely inhibiting recrystallization of ice rather than preventing initial ice formation.

Another known and important aspect of plant pathogens and pests above the root crown is the amount of water vapor in the air or a gas mixture (i.e. humidity; absolute, relative, and specific) about the plant shoot.

A related environmental parameter is dew point; the air temperature causing the air to saturate with water vapor. When further cooled, airborne water vapor will condense to form liquid water (i.e. dew, fog, or condensation). When air or a gas mixture temperature is reduced via contact with a surface that is colder than the surrounding air or gas mixture, water will condense on the surface. A surface may include a living plant and its physical surroundings such as a greenhouse interior, and the like. A fixed water vapor results in higher relative humidity in colder air than in warmer.

When an air temperature is below the freezing point of water, the dew point is called the frost point; as frost is formed on a surface rather than condensation. The measurement of dew and frost point is related to humidity in that the higher the dew or frost point temperature; the more moisture may be held in an air/gas mixture.

What is desired is a method and system of and for improving the growth of plants by providing a plant nutrient solution temperature and/or a gas mixture temperature intolerant to plant pathogens and pests in order to prevent, treat, control, and/or eradicate infection by and of plant pathogens and/or infestation by and of plant pests, wherein the provided gas mixture and/or nutrient solution temperature does not cause irremediable damage to or the death of the plant.

What is desired is a method and system of and for improving the growth of plants by providing a gas mixture relative humidity intolerant to plant pathogens and pests in order to prevent, treat, control, and/or eradicate infection by and of plant pathogens and/or infestation by and of plant pests, wherein the provided gas mixture relative humidity does not cause irremediable damage to or the death of the plant.

What is desired is a method and system of and for improving the growth of plants by providing a gas mixture relative humidity intolerant to plant pathogens and pests in order to prevent, treat, control, and/or eradicate infection by and of plant pathogens and/or infestation by and of plant pests, wherein the provided gas mixture temperature is at or below the dew point temperature of the provided gas mixture and provided relative humidity; and does not cause irremediable damage to or the death of the plant.

What is desired is a method and system of and for improving the growth of plants by providing a gas mixture relative humidity intolerant to plant pathogens and pests in order to prevent, treat, control, and/or eradicate infection by and of plant pathogens and/or infestation by and of plant pests, wherein the provided gas mixture temperature is at or below the frost point temperature of the provided gas mixture and provided relative humidity; and does not cause irremediable damage to or the death of the plant.

### SUMMARY OF THE INVENTION

It is an object of the instant invention to provide a method of improving the growth of a plant, the method comprising the steps of: providing a plant having roots and a shoot; providing a plant growing system configured for growing the plant, the plant growing system including a plant nutrient solution about the plant roots and a gas mixture circulating about the plant shoot; selecting a plant nutrient solution temperature; selecting a gas mixture temperature based at least in part upon the plant nutrient solution temperature; providing a plant nutrient solution to gas mixture temperature differential of at least approximately 10° F.; and whereby the selected gas mixture temperature or the selected nutrient solution temperature prevents, treats, controls, or eradicates a plant pathogen or plant pest without causing irreparable damage to or the death of the plant.

It is an object of the instant invention to provide a method of improving the growth of a plant wherein the selected gas mixture temperature is above the selected nutrient solution temperature.

It is an object of the instant invention to provide a method of improving the growth of a plant wherein the selected gas mixture temperature is below the selected nutrient solution temperature.

It is an object of the instant invention to provide a method of improving the growth of a plant wherein the selected shoot to root temperature differential is greater than approximately 30° F.

It is an object of the instant invention to provide a method of improving the growth of a plant wherein the selected gas mixture temperature is below approximately 40° F. and above a temperature which causes irreparable damage to or the death of the plant.

It is an object of the instant invention to provide a method of improving the growth of a plant wherein the selected nutrient solution temperature is below approximately 40° F. and above a temperature which causes irreparable damage to or the death of the plant.

It is an object of the instant invention to provide a method of improving the growth of a plant wherein the gas mixture humidity and temperature are below the gas mixture dew point.

It is an object of the instant invention to provide a method of improving the growth of a plant, wherein the gas mixture humidity and temperature are below the gas mixture frost point.

It is an object of the instant invention to provide a method of improving the growth of a plant wherein the gas mixture temperature is above 80° F. and the relative humidity below approximately 30%.

It is an object of the instant invention to provide a method of improving the growth of a plant wherein the shoot to root temperature differential is based at least in part on the plant variety, based at least in part on the plant nutrient solution N—P—K concentration level, and based at least in part on the plant growth phase.

It is an object of the instant invention to provide a method of improving the growth of a plant wherein the gas mixture comprises air, and the method further comprising the step of increasing the carbon-dioxide level of the air based at least in part upon the selected plant nutrient solution temperature and at least in part on the selected air temperature.

It is an object of the instant invention to provide a method of improving the growth of a plant wherein any change to the selected gas mixture temperature or the selected plant nutrient solution temperature is made in less than approximately 20° F. increments during any one twenty-four hour period.

It is an object of the instant invention to provide a method of preventing, treating, controlling, or eradicating an infection or infestation by a plant pathogen or plant pest, the method comprising the steps of: providing a plant having roots and a shoot; providing a plant growing system configured for growing the plant having roots and a shoot, the plant growing system including a plant nutrient solution about the plant roots and a gas mixture circulating about the plant shoot; lowering either the gas mixture temperature or the nutrient solution temperature independently of the other until the lowered temperature prevents, treats, controls, or eradicates a plant pathogen or plant pest; and wherein the lowered gas mixture temperature or lowered nutrient solution temperature does not cause irreparable damage to or the death of the plant.

It is an object of the instant invention to provide a method of preventing, treating, controlling, or eradicating an infection or infestation by a plant pathogen or plant pest wherein the lowered gas mixture temperature or the lowered plant nutrient solution temperature prevents, treats, controls, or eradicates a plant pathogen or plant pest belonging to the group consisting of insects, fungi, molds, mildews, bacterium, germs, viruses, nematodes, protozoans and combinations thereof.

It is an object of the instant invention to provide a system configured to grow a plant having roots and a shoot, the plant growing system comprising: a plant nutrient solution located about the roots of the plant; a gas mixture circulating about the shoot of the plant; wherein the selected temperature of gas mixture is selected independently of the selected temperature of the plant nutrient solution; wherein the plant nutrient solution to gas mixture temperature differential is at least approximately 10° F.; and whereby the selected gas mixture temperature or the selected nutrient solution temperature prevents, treats, controls, or eradicates a plant pathogen or plant pest without causing irreparable damage to or the death of the plant.

It is an object of the instant invention to provide a system configured to grow a plant having roots and a shoot wherein the system is insulated, air-tight, and water-tight to the extent required as to maintain the temperature differential between the plant root and the plant shoot.

It is an object of the instant invention to provide a system configured to grow a plant having roots and a shoot further comprising material placed between the plant shoot and the plant root to maintain the temperature differential between the plant root and the plant shoot.

It is an object of the instant invention to provide a system configured to grow a plant having roots and a shoot further comprising material suspended over or about the plant shoot to provide a temperature differential between the plant root and the plant shoot.

It is an object of the instant invention to provide a system configured to grow a plant having roots and a shoot further comprising an irrigation system to deliver the plant nutrient solution to the roots of the plant.

It is an object of the instant invention to provide a system configured to grow a plant having roots and a shoot wherein the system is self-contained except for electrical input, water input, water output, and ventilation.

It is an object of the instant invention to provide a system configured to grow a plant having roots and a shoot wherein the system is self-contained except for solar input, water input, water output, and ventilation.

It is an object of the instant invention to provide a system configured to grow a plant having roots and a shoot wherein the system is portable.

It is an object of the instant invention to provide a system configured to grow a plant having roots and a shoot, wherein the system is configured to grow a plant in zero gravity.

### BRIEF DESCRIPTION OF THE DRAWINGS

FIG. 1 is a schematic diagram of an embodiment of the inventive method and system.

FIG. 2 is a schematic diagram of an embodiment of the inventive method and system.

FIG. 3 is a schematic diagram of an embodiment of the inventive method and system.

FIG. 4 is a schematic diagram of a plant's development indicative of a period of low root temperature provided to prevent or treat infection by a plant pathogen or pest.

FIG. 5 is a schematic diagram of a plant's development indicative of periods of low root temperature provided to prevent or treat infection by a plant pathogen or pest.

FIG. 6 is a schematic diagram of a plant's development indicative of a period of low shoot temperature provided to prevent or treat infection by a plant pathogen or pest.

FIG. 7 is a schematic diagram of a plant's development indicative of periods of low shoot temperature provided to prevent or treat infection by a plant pathogen or pest.

### DETAILED DESCRIPTION OF THE INVENTION

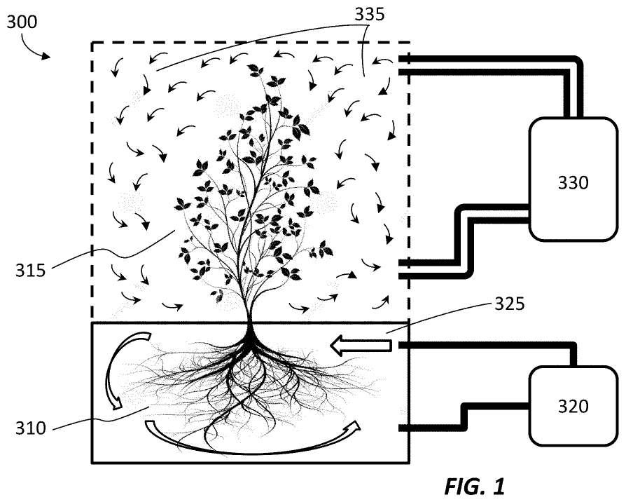

As depicted in FIG. 1, the inventive method and system provides a plant growing system (300) configured for growing a plant having roots (310) and a shoot (315). The plant growing system includes a plant nutrient solution (320) about (325) the plant roots (310) and a gas mixture (330) circulating about (335) the plant shoot (315).

It is contemplated that the plant growing system (300) is insulated, air-tight, and water-tight to the extent required as to maintain a desired temperature differential between the plant root (310) and plant shoot (315), and a selected humidity of the gas mixture surrounding the plant shoot.

Many and varied plant growing system types and techniques may be provided; such as hydroponic drip, ebb and flow, nutrient film technique, deep water culture, wick systems, aquaponic system, and the like, and to include known configurations which may be easily adapted to independently select and maintain both plant root (310) and plant shoot (315) temperatures, and independently provide a selected gas mixture humidity.

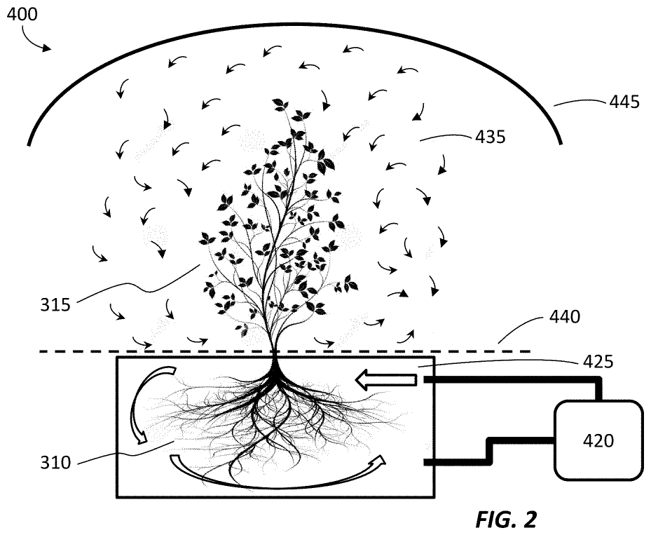

As depicted in FIG. 2, the inventive method and system provides a plant growing system (400) adapted for outdoor hydroponic or aquaponic cultivation of a plant having roots (310) and a shoot (315). The plant growing system (400) includes a plant nutrient solution (420) about (425) the plant roots (310) and allows for air to circulate about (435) the plant shoot (315).

It is contemplated that the plant growing system is insulated and water-tight to the extent required as to maintain a desired temperature differential between the plant root (310) and plant shoot (315). Additionally, insulative light reflecting or absorbing material (440) may be placed between the plant shoot and root to facilitate and maintain a desired temperature differential. Still further, insulative or dissipative light reflecting or absorbing material (445) may be suspended over the plant shoot (315) to facilitate and maintain a desired temperature differential. Many and varied plant growing system (400) types and techniques may be provided; such as hydroponic drip, ebb and flow, nutrient film technique, deep water culture, wick systems, aquaponic system, and the like, and to include known configurations which may be easily adapted to select and maintain a plant root (310) temperature independently of the circulating air (435) temperature and/or plant shoot (315) temperature.

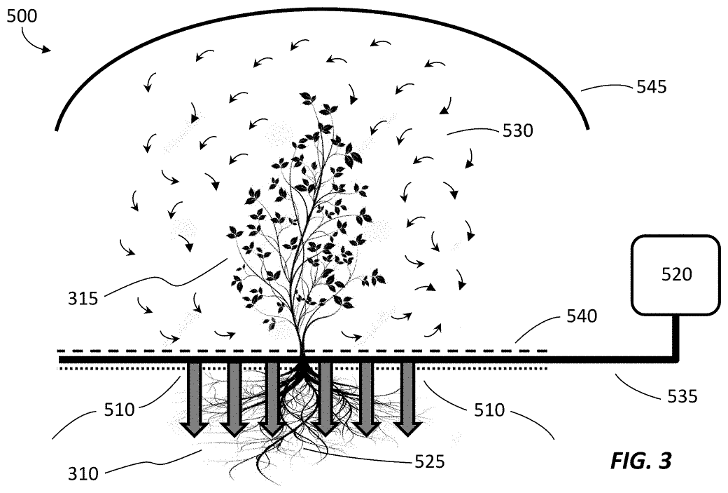

As depicted in FIG. 3, the inventive method and system provides a plant growing system (500) adapted to outdoor soil (510) based irrigation farming of a plant having roots (310) and a shoot (315). The plant growing system (500) includes an irrigation plant nutrient solution (520) which is conveyed to the plant roots (525) via conventional irrigation means other than “through the air broadcast” or “sprinkler type” techniques. Preferably, drip or troth type irrigation techniques are used as to not alter the shoot (315) temperature of the plant when a temperature differential is desired. Based at least in part on the temperature of the air allowed to circulate about (530) the plant shoot (315), the irrigation plant nutrient solution (520) temperature is selected to provide a desired shoot to root temperature differential.

It is contemplated that the plant growing system (500) is insulated and water-tight to the extent required as to maintain a desired temperature differential between the plant root (310) and plant shoot (315). An exemplary plant growing system includes irrigation pipe (535) conveying irrigation nutrient solution (520) through the soil (510) and about (525) the plant roots (310). Additionally, insulative or dissipative light reflecting or absorbing material (540) may be placed between the plant shoot and root to facilitate and maintain a desired temperature differential.

Still further, insulative or dissipative light reflecting or absorbing material (545) may be suspended over the plant shoot (315) to facilitate and maintain a desired temperature differential. Many and varied outdoor soil-based plant growing system (500) and techniques may be adapted to select and maintain a plant root (310) temperature independently of the circulating air (530) temperature and/or plant shoot (315) temperature.

While not wishing to be bound by any one theory or combination of theories, it is accepted as true by the inventor that: the timing, sequence, and range of shoot-to-root temperature differentials selected during plant development and the gas mixture humidity about a plant shoot may be utilized to prevent, treat, control, and/or eradicate plant pathogens and/or plant pests; and, thereby improve plant growth for industrial, scientific, and medical purposes.

While not wishing to be bound by any one theory or combination of theories, it is accepted as true by the inventor that while maintaining a plant root system at a traditional temperature range, typically between 55° F. and 85° F.; and providing a shoot temperature and humidity of or in four general categories: low temperature with low humidity (cold and dry), low temperature and high humidity (cold and wet), high temperature and low humidity (hot and dry), and high temperature and high humidity (hot and wet); may be utilized to prevent, treat, control, and/or eradicate plant pathogens and/or plant pests; and, thereby improve plant growth for industrial, scientific, and medical purposes.

Hereinafter, an approximate 10° F. or greater shoot to root temperature differential will be symbolized either as a “>10° F.+/−” or as a “>10° F.−/+” temperature condition; the first position representing selected shoot temperature, and the second position representing selected root temperature, and the “+” and “−” indicative of whether the shoot or root temperature is above or below the other.

Hereinafter, an approximate 0° F. shoot to root temperature differential will be symbolized as a “0° F. S/R” temperature condition.

Some plant varieties are relatively small in size and lend themselves to modern hydroponic, aeroponic, and/or aquaponic growing methods and systems. Therefore, providing effective shoot to root temperature differentials for a variety is extremely easy using a plant growing system similar to as described in FIG. 1, FIG. 2, and FIG. 3.

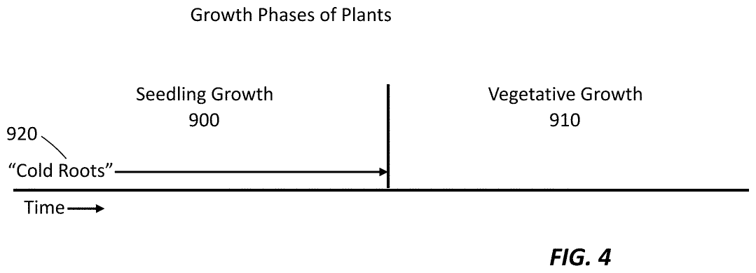

As depicted in FIG. 4, in another embodiment of the instant inventive method and system, a plant variety root temperature is reduced wherein the plant nutrient solution temperature is harmful to plant pathogens wherein the pathogens become intolerant of the temperature. Plants in the seedling growth phase may be placed in this “cold roots” temperature condition (920) in order to prevent or eradicate infection by a pathogen or pest, while maintaining both vigorous shoot and root growth.

To prevent plant root hypoxia which in turn prevents onset of pathogen or pest infection and infestation, and to increase nutrient uptake by a plant; intelligently so, the vast majority of cultivators reduce water and/or nutrient solution and grow medium temperatures to between 55-70 degrees F. regardless of the air/gas mixture provided and maintained. This indeed will increase oxygen solubility making supplementary oxygen bubblers, injectors, and the like much more effective and efficient. However, this common nutrient temperature reduction while maintaining the plant shoot at higher temperatures results in a shoot to root temperature differential condition which stunts and retards growth and development of plants; from seedlings to harvest.

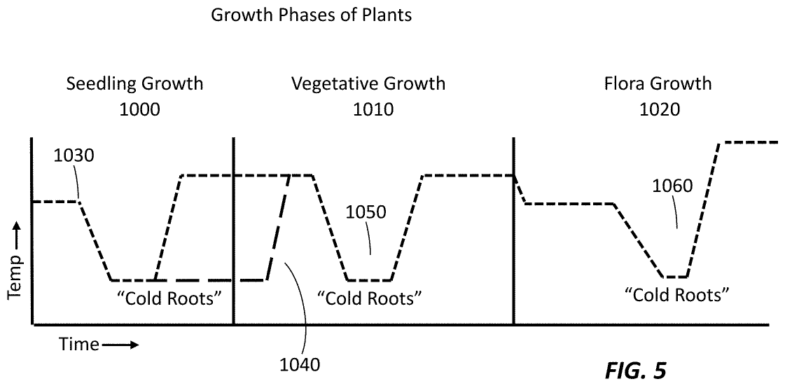

As depicted in FIG. 5, in an embodiment of the instant inventive method and system, as observed by the instant inventor, temporarily reducing plant nutrient solution temperature (1030) for the purpose of eradicating or preventing infection by a harmful plant pathogen or pest has no or little physiological ontogenic or morphogenic effect on a plant if the period of “cold roots” is approximately less than 3-5 days in duration; dependent upon the shoot temperature and root temperature selected. This therapeutic period of “cold roots” may be accomplished during either plant seedling growth (1000) vegetative growth (1010) or flora growth (1020) phases. As depicted by temperature line (1040), preferably if a plant is placed in a therapeutic “cold roots” condition during seedling growth, in order to prevent pathogen or pest re-infection, the plant may remain in that “cold roots” condition until morphogenic changes for a particular growing sequence requires an increase in plant root temperature.

As observed during instant inventor experimentation, several periods of therapeutic “cold roots” of 3-5 days duration (1050,1060) were executed randomly throughout both plant vegetative and flora growth phases without noticeable morphogenic difference, as compared to plants which were not placed in a therapeutic “cold root” condition.

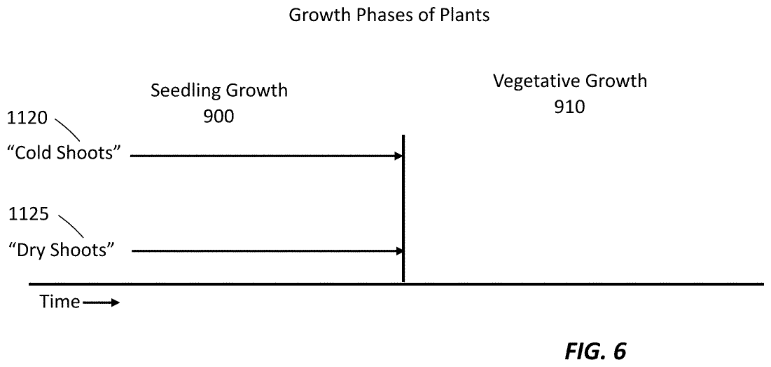

As depicted in FIG. 6, in another embodiment of the instant inventive method and system, a plant shoot temperature is reduced wherein the plant air or gas mixture temperature is harmful to plant pathogens or pests wherein the pathogens or pests become intolerant of the reduced gas mixture temperature. Plants in the seedling growth phase may be placed in this “cold shoot” temperature condition (1120) in order to prevent or eradicate infection or infestation by a pathogen or pest, while maintaining both vigorous shoot and root growth.

It is contemplated that in conjunction with a “cold shoot” temperature condition (1120); gas mixture humidity may be reduced to provide a “dry shoot” condition (1125) providing a “cold and dry” environment to prevent and/or treat plant pathogens and/or pests.

It should be noted that during seedling growth phase, little if any significant developmental changes were observed by the instant inventor; therefore, a primary objective in reducing shoot temperature during seedling growth is the prevention or treatment of a harmful plant pathogen and/or pest.

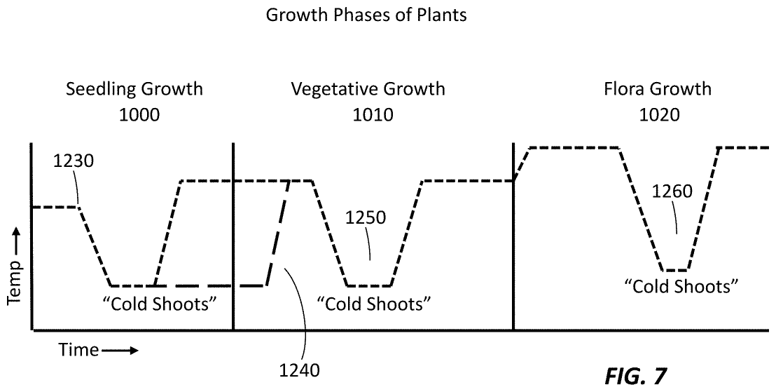

As depicted in FIG. 7, in another embodiment of the instant inventive method and system, as observed by the instant inventor, temporarily reducing plant gas mixture temperature (1230) for the purpose of eradicating or preventing infection by a harmful pathogen or pest has no or little physiological ontogenic or morphogenic affect if the period of “cold shoot” is approximately less than 3-5 days in duration. This therapeutic period of “cold shoot” may be accomplished during either plant seedling growth (1000) vegetative growth (1010) or flora growth (1020) phases. As depicted by temperature line (1240), preferably if a plant is placed in a therapeutic “cold shoot” condition during seedling growth, in order to prevent pathogen or pest re-infection, the plant may remain in that “cold shoot” condition until morphogenic changes for a particular growing sequence requires an increase in plant gas mixture temperature. As observed during instant inventor experimentation, several periods of therapeutic “cold shoot” of 3-5 days duration (1250,1260) were executed randomly throughout both plant vegetative and flora growth phases without noticeable morphogenic difference, as compared to plants which were not placed in a therapeutic “cold shoot” condition.

It is contemplated that in conjunction with a “cold shoot” temperature condition (1120); gas mixture humidity may be reduced to provide a “dry shoot” condition providing a “cold and dry” environment to prevent and/or treat plant pathogens and/or pests

It is contemplated that a period of therapeutic “cold shoots” or “cold roots” may be routinely and/or periodically provided during various phases of plant development to prevent initial infection or re-infestation by a plant pathogen or pest.

While not wishing to be bound by any one theory or combination of theories, after instant inventor experimentation and observation—it is accepted as true by the inventor that: when a plant is placed in a shoot to root temperature differential condition, the warmer portion of the plant allows for and enables the plant overall to withstand extreme cold at the colder portion of the plant, even below freezing, for hours to days without causing irremediable harm to or the death of the plant; which shoot to root temperature differential may be utilized to prevent, treat, control, and/or eradicate plant pathogens and/or plant pests and thereby improve plant growth for industrial, scientific, and medical purposes and uses.

While not wishing to be bound by any one theory or combination of theories, after instant inventor experimentation and observation—it is accepted as true by the inventor that: when a plant is placed in a shoot to root temperature differential condition, the warmer portion of the plant allows for and enables the plant overall to withstand extreme cold at the colder portion of the plant, even below freezing, for hours to days without causing irremediable harm to or the death of the plant; which the air mixture about the plant shoot humidity may be utilized in conjunction with a shoot to root temperature differential to prevent, treat, control, and/or eradicate plant pathogens and/or plant pests and thereby improve plant growth for industrial, scientific, and medical purposes and uses.

When changes are made in plant environmental temperature, preferably the change should be made gradually rather than abruptly; as to avoid overly stressing the plant. Such stress may cause growth retardation and stunt the plant overall. Preferably, selected gas mixture temperature and/or plant nutrient solution temperature changes should be less than approximately 20° F. in any one twenty-four-hour period.

It is contemplated that utilizing carbon-dioxide augmentation during plant development allows for increased gas mixture temperatures, and therefore increased shoot to root temperature differentials. The increased shoot to root temperature differentials allowed by utilizing carbon-dioxide augmentation results in improved pathogen and pest eradication, and thus reduces cultivation cost and time while increasing crop yields.

It should be understood that all Figures herein are merely illustrative of various aspects of the instant inventive method and system and are not intended to be accurate or to scale as to time, temperature, or physical dimensions related to the described inventive shoot to root temperature sequence.

Although the inventive method and system has been described with reference to a particular sequence of shoot to root temperature differentials, temperature values, humidity values, and the like, these are not intended to exhaust all possible sequences, temperatures or humidity's, and indeed many other modifications and variations will be ascertainable by those of ordinary skill in the art.

It is contemplated that various plant families and genera may be improved by practicing the inventive method and system, without departing from the objectives and scope of the instant invention. It is contemplated this group includes modern green algae, seedless non-vascular, seedless vascular, gymnosperm, and angiosperm plant families.

The instant invention as described is not to be limited by the embodiments as shown in the drawings and/or as described in the specification, since these are given by way of example only and not by way of limitation.

Having thus described several embodiments for practicing the inventive method and system, its advantages and objectives may be understood. Variations from the drawings and description may be made by one skilled in the art without departing from the scope of the invention, which is to be determined from the following claims.

What is claimed is:

1. A method of improving the growth of a plant, the method comprising the steps of:
providing a plant having roots and a shoot;
providing a plant growing system configured for growing the plant, the plant growing system including a plant nutrient solution about the plant roots and a gas mixture circulating about the plant shoot;
selecting a plant nutrient solution temperature;
selecting a gas mixture temperature based at least in part upon the plant nutrient solution temperature;
providing a plant nutrient solution to gas mixture temperature differential of at least approximately 10° F.; and
whereby the selected gas mixture temperature or the selected nutrient solution temperature prevents, treats, controls, or eradicates a plant pathogen or plant pest without causing irreparable damage to or the death of the plant.

2. The method of claim 1 wherein the selected gas mixture temperature is above the selected nutrient solution temperature.

3. The method of claim 1 wherein the selected gas mixture temperature is below the selected nutrient solution temperature.

4. The method of claim 1 wherein the selected shoot to root temperature differential is greater than approximately 30° F.

5. The method of claim 1 wherein the selected gas mixture temperature is below approximately 40° F. and above a temperature which causes irreparable damage to or the death of the plant.

6. The method of claim 1 wherein the selected nutrient solution temperature is below approximately 40° F. and above a temperature which causes irreparable damage to or the death of the plant.

7. The method of claim 1, wherein the gas mixture humidity and temperature are below the gas mixture dew point.

8. The method of claim 1, wherein the gas mixture humidity and temperature are below the gas mixture frost point.

9. The method of claim 1, wherein the gas mixture temperature is above 80° F. and the relative humidity below approximately 30%.

10. The method of claim 1 wherein the shoot to root temperature differential is based at least in part on the plant variety, based at least in part on the plant nutrient solution N—P—K concentration level, and based at least in part on the plant growth phase.

11. The method of claim 1 wherein the gas mixture comprises air, and the method further comprising the step of increasing the carbon-dioxide level of the air based at least in part upon the selected plant nutrient solution temperature and at least in part on the selected air temperature.

12. The method of claim 1 wherein any change to the selected gas mixture temperature or the selected plant nutrient solution temperature is made in less than approximately 20° F. increments during any one twenty-four hour period.

13. A method of preventing, treating, controlling, or eradicating an infection or infestation by a plant pathogen or plant pest, the method comprising the steps of:
providing a plant having roots and a shoot;
providing a plant growing system configured for growing the plant having roots and a shoot, the plant growing system including a plant nutrient solution about the plant roots and a gas mixture circulating about the plant shoot;
lowering either the gas mixture temperature or the nutrient solution temperature independently of the other until the lowered temperature prevents, treats, controls, or eradicates a plant pathogen or plant pest; and
wherein the lowered gas mixture temperature or lowered nutrient solution temperature does not cause irreparable damage to or the death of the plant.

14. The method of claim 13, wherein the lowered gas mixture temperature or the lowered plant nutrient solution temperature prevents, treats, controls, or eradicates a plant pathogen or plant pest belonging to the group consisting of insects, fungi, molds, mildews, bacterium, germs, viruses, nematodes, protozoans and combinations thereof.

15. A plant growing system configured to grow a plant having roots and a shoot, the plant growing system comprising:
a plant nutrient solution located about the roots of the plant;
a gas mixture circulating about the shoot of the plant;
wherein the selected temperature of gas mixture is selected independently of the selected temperature of the plant nutrient solution;
wherein the plant nutrient solution to gas mixture temperature differential is at least approximately 10° F.; and
whereby the selected gas mixture temperature or the selected nutrient solution temperature prevents, treats, controls, or eradicates a plant pathogen or plant pest without causing irreparable damage to or the death of the plant.

16. The plant growing system of claim 15, wherein the system is insulated, air-tight, and water-tight to the extent required as to maintain the temperature differential between the plant root and the plant shoot.

17. The plant growing system of claim 15, further comprising material placed between the plant shoot and the plant root to maintain the temperature differential between the plant root and the plant shoot.

18. The plant growing system of claim 15, further comprising material suspended over or about the plant shoot to provide a temperature differential between the plant root and the plant shoot.

19. The plant growing system of claim 15, wherein the system is self-contained except for solar input, electrical input, water input, water output, and/or ventilation.

20. The plant growing system of claim 15, wherein the system is portable.
